(19) United States
(12) Patent Application Publication
(10) Pub. No.: US 2026/0116229 A1
(43) Pub. Date: Apr. 30, 2026

(54) CONTAINERIZED EV CHARGING HUB WITH SOLAR INTEGRATION AND MICROGRID CAPABILITY

(71) Applicant: EV Innovations, LLC, Dallas, TX (US)

(72) Inventor: Tim Sales, Prosper, TX (US)

(21) Appl. No.: 19/370,345

(22) Filed: Oct. 27, 2025

Related U.S. Application Data
(60) Provisional application No. 63/712,287, filed on Oct. 25, 2024.

(51) Int. Cl. B60L 53/302; B60L 53/12; B60L 53/14; B60L 53/51; B60L 53/52; B60L 53/53; B60L 53/57; B64U 50/38; H02J 7/35

(52) U.S. Cl. CPC B60L 53/302; B60L 53/12; B60L 53/14; B60L 53/51; B60L 53/52; B60L 53/53; B60L 53/57; B64U 50/38; H02J 7/35; B60L 2200/10

(57) ABSTRACT

A modular electric vehicle (EV) charging station may be integrated with Battery Energy Storage System (BESS) capabilities. The charging station may provide a modular architecture, allowing for scalable deployment in various locations, from urban environments to remote areas. The modular design may enable easy expansion or upgrading of the station's charging capacity and power output. Integrating BESS within the charging station may ensure a reliable and efficient energy supply, even in areas with unstable grid connections or in areas experiencing catastrophic weather events resulting in lost power. The BESS may store energy during off-peak hours or from renewable sources, such as solar, and deliver that energy during peak demand periods, thereby reducing energy costs and alleviating strain on the local power grid. The system may be equipped with advanced energy management software that optimizes charging times, balances loads, and enhances overall efficiency for ground and/or aerial electric vehicles (EVs).

### CROSS-REFERENCE TO RELATED APPLICATION

The present application is a non-provisional of, and claims priority to, U.S. patent application Ser No. 63/712,287 filed Oct. 25, 2024, the disclosure of which is incorporated by reference in its entirety.

### FIELD OF THE DISCLOSURE

The present disclosure generally relates to enhancing electric vehicle (EV) charging infrastructure, and more particularly, to a modular containerized EV charging hub with integrated solar power and microgrid and optional aerial-vehicle (drone) wireless charging capabilities for decentralized and renewable energy applications.

### BACKGROUND

Current EV charging infrastructure is often limited by the need for fixed installations, high construction costs, and dependence on the electrical grid, making it difficult to scale quickly or deploy in remote areas whatsoever. Existing solutions also lack integration with renewable energy sources, contributing to inefficient energy use.

### SUMMARY

Embodiments of the present disclosure may provide a modular electric vehicle (EV) charging station/hub integrated with Battery Energy Storage System (BESS) capabilities, which may revolutionize the EV charging experience for both fleet and consumer vehicles. The charging station according to embodiments of the present disclosure may provide a modular architecture, allowing for scalable deployment in various locations, from urban environments to remote areas. The modular design may enable easy expansion or upgrading of the station's charging capacity and power output, accommodating future increases in EV adoption and evolving technological standards.

Integrating BESS within the charging station in embodiments of the present disclosure may ensure a reliable and efficient energy supply, even in areas with unstable grid connections or in areas experiencing catastrophic weather events resulting in lost power. The BESS may store energy during off-peak hours or from renewable sources, such as solar, and deliver that energy during peak demand periods, thereby reducing energy costs and alleviating strain on the local power grid. The station/hub may be equipped with advanced energy management software that optimizes charging times, balances loads, and enhances overall efficiency.

In certain embodiments, the modular charging hub may further include a drone-charging subsystem mounted on or integrated into the container's upper surface. The subsystem may employ inductive, resonant, or directed-beam wireless power transfer to recharge aerial drones, inspection units, and/or autonomous delivery vehicles. Power may be drawn from the charging station's internal Battery Energy Storage System (BESS), solar array, or microgrid interface, enabling autonomous air-and-ground energy distribution from a single deployable platform.

The modular electric vehicle (EV) charging station integrated with BESS according to embodiments of the present disclosure may reduce installation time and costs, improve energy efficiency while energy costs are reduced, and enhance flexibility in deployment often at a moment's notice. It can be deployed anywhere, independent of grid access, thanks to integrated solar power and microgrid capabilities. Its portable design, scalability, and renewable energy integration may provide a flexible, sustainable alternative. The station may be particularly well-suited for fleet operators, commercial properties, apartment communities, and municipalities seeking to support the growing demand for EV infrastructure while minimizing environmental impact, operational, and construction costs.

Embodiments of the present disclosure may provide a modular electric vehicle (EV) charging station comprising: a container formed of a durable material; one or more integrated solar panels on the container; a battery energy storage system (BESS) paired with the one or more integrated solar panels; and one or more EV charging pads compatible with a plurality of electric vehicles. The one or more integrated solar panels may be on a roof of the container or on one or more side surfaces of the container. The modular EV charging station may be wired or wireless. The modular EV charging station may fit within a standard parking space without exceeding dimensions of the standard parking space. The modular EV charging station may also include a plurality of EV charging ports. Each of the plurality of EV charging ports may comprise a charge confirm display, internal EV charging equipment, and an EV charging cable. The modular EV charging station may further include one or more doors on an end of the container that allow access to internal components of the modular EV charging station. The internal components may comprise an internal power core cell system and an internal climate control system. The modular EV charging station also may include a drone charging subsystem disposed on a roof of the container. The drone charging subsystem may employ one or more of the following power transfer mechanisms for charging: inductive power transfer, resonant power transfer, and directed-beam wireless power transfer. The power may be drawn from the BESS, the one or more solar panels, and/or a microgrid surface. The drone charging subsystem may be removable, retractable, or configurable to accommodate a plurality of drone sizes. The modular EV charging station may be in a fixed position or may be mobile for temporary positioning. The modular EV charging station may be grid-connected through to a local power grid. The modular EV charging station may incorporate small-scale wind turbines. The modular EV charging station may be configured as a mobile unit mountable on a truck or a trailer. The modular EV charging station may be operable as a portable battery storage unit charged through external sources.

### BRIEF DESCRIPTION OF THE DRAWINGS

For a more complete understanding of this disclosure, reference is now made to the following description, taken in conjunction with the accompanying drawings, in which:

FIG. 1 depicts an aerial view of a modular EV charging station relative to the dimensions for a standard parking space in North America according to an embodiment of the present disclosure;

FIG. 2 depicts a perspective side view of a modular EV charging station according to an embodiment of the present disclosure;

FIG. 3 depicts a container housing a modular EV charging station according to an embodiment of the present disclosure;

FIG. 4 depicts an aerial view of a modular EV charging station within a standard parking space according to an embodiment of the present disclosure;

FIG. 5 depicts a retail application of a modular EV charging station according to an embodiment of the present disclosure;

FIG. 6 depicts wired charging using a modular EV charging station according to an embodiment of the present disclosure;

FIG. 7 depicts wireless charging using a modular EV charging station according to an embodiment of the present disclosure;

FIG. 8 depicts another configuration of a modular EV charging station according to an embodiment of the present disclosure;

FIG. 9 depicts another view of a wireless modular EV charging station according to an embodiment of the present disclosure;

FIGS. 10A-10E depict views of a wireless drone-charging module positioned on the top surface of the container according to an embodiment of the present disclosure.

### DETAILED DESCRIPTION

Embodiments of the present disclosure may provide a modular electric vehicle (EV) charging station integrated with Battery Energy Storage System (BESS) capabilities. It should be appreciated that “vehicles” as used herein may include aerial, terrestrial, and/or or amphibious autonomous conveyances. In an embodiment of the present disclosure, a self-contained, modular charging station may be housed/provided in a durable container for easy transport and deployment. The container may be formed of weathering steel, which may be referred to as corten steel, in an embodiment of the present disclosure; however, other durable materials may be used without departing from the present disclosure. The container forming the station may include one or more integrated solar panels on the roof and/or side surfaces paired with battery energy storage to collect and store solar energy. The container may include one or more standard EV charging ports or pads that may be compatible with fleet and/or consumer electric vehicles, whether they be ground or aerial vehicles (i.e., drones, unmanned aerial vehicles (UAVs). The modular EV charging station may be wired or wireless in embodiments of the present disclosure.

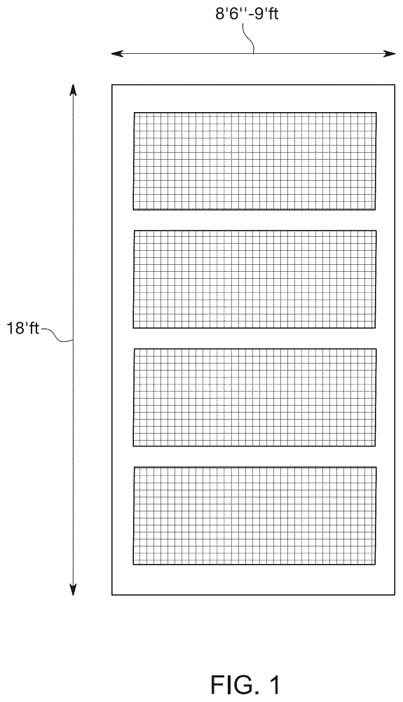

FIG. 1 depicts an aerial view of a modular EV charging station relative to the dimensions for a standard parking space in North America according to an embodiment of the present disclosure. As depicted herein, a standard parking space may be 8.5-9 feet wide and 18 feet long. Accordingly, the modular EV charging station may fit within the parking space without exceeding the dimensions of the parking space. Further, as depicted herein, the roof of the container forming the modular EV charging station may include four solar panels; however, more or fewer solar panels may be included without departing from the present disclosure.

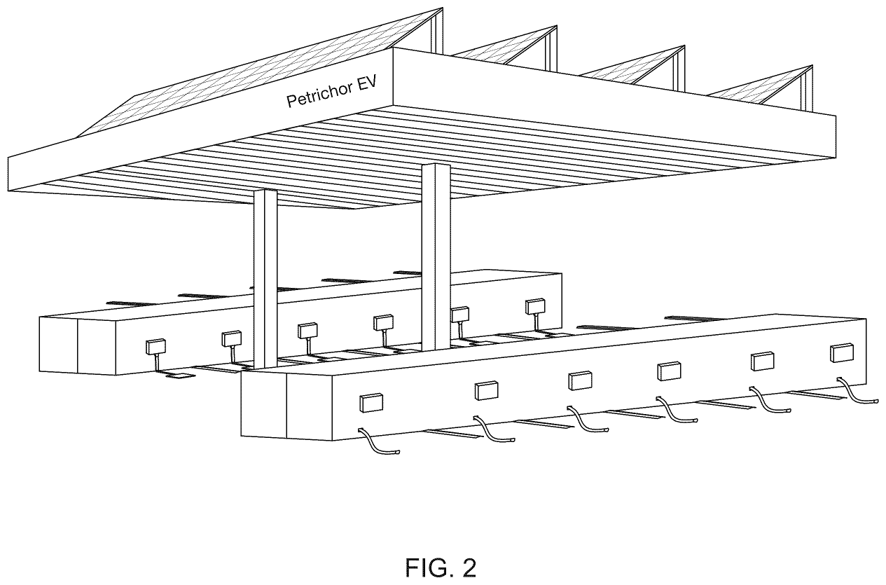

FIG. 2 depicts a perspective side view of a modular EV charging station according to an embodiment of the present disclosure. As depicted herein, the container forming the modular EV charging station may include four solar panels on the roof; however, more or fewer solar panels may be included without departing from the present disclosure. The modular EV charging station is depicted as having a plurality of standard EV charging ports. While 12 ports are depicted in FIG. 2, it should be appreciated that more or fewer EV charging ports may be included without departing from the present disclosure.

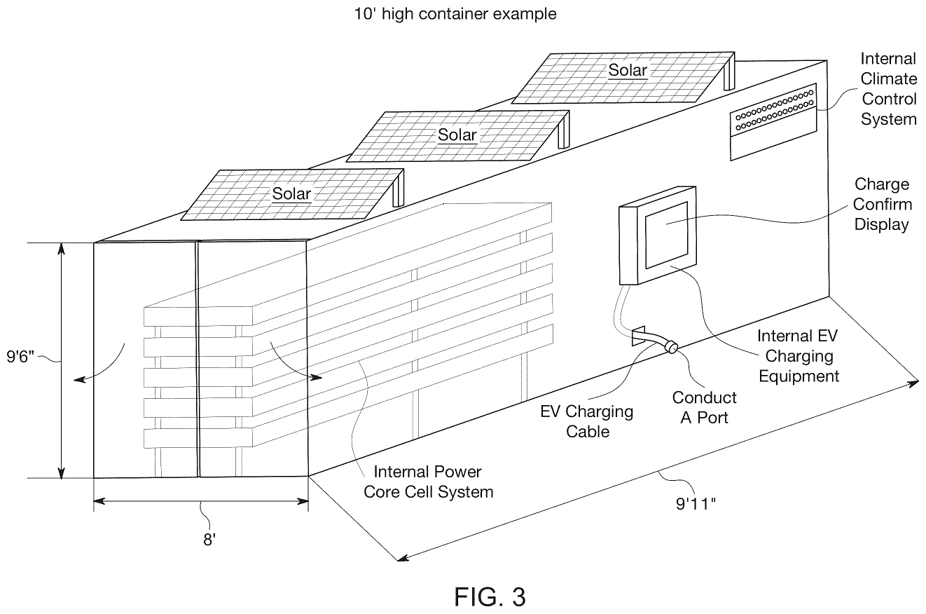

FIG. 3 depicts a container housing or forming a modular EV charging station according to an embodiment of the present disclosure. The container in FIG. 3 is depicted as a 10-foot-high container; however, larger or smaller containers may be used without departing from the present disclosure. The container may have a set of swinging doors on one end of the container to allow for the internal components of the modular EV charging station to be accessed. Internal components may include, but are not limited to, an internal power core cell system and internal climate control system. FIG. 3 also depicts an EV charging port which may include, but is not limited to, a charge confirm display, internal EV charging equipment, and an EV charging cable. While only one EV charging port is depicted in FIG. 3, it should be appreciated that a plurality of EV charging ports may be provided in embodiments of the present disclosure. Also, as depicted herein, the container may include three solar panels on the roof; however, more or fewer solar panels may be included without departing from the present disclosure.

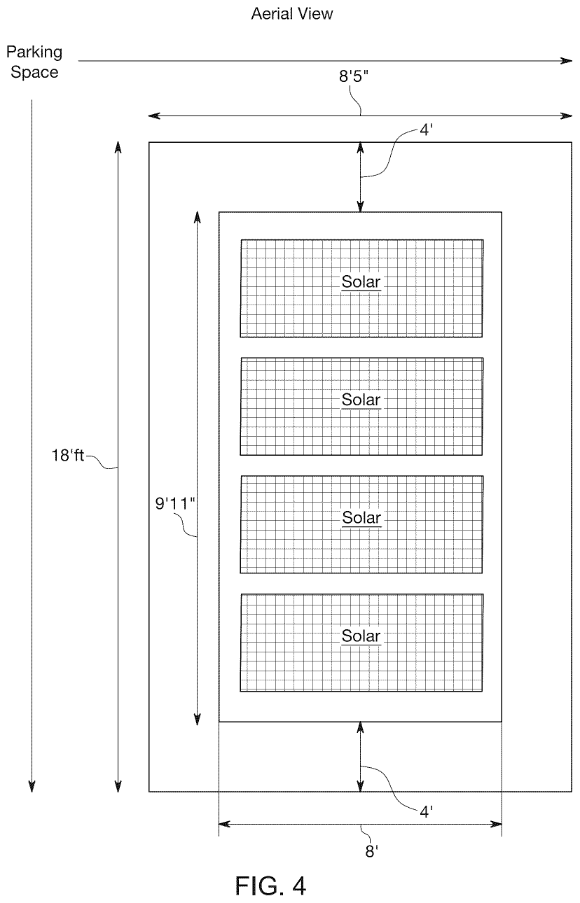

FIG. 4 depicts an aerial view of a modular EV charging station within a standard parking space according to an embodiment of the present disclosure. More specifically, FIG. 4 depicts dimensions of a container housing the modular EV charging station as it would be placed within the dimensions of a standard parking space.

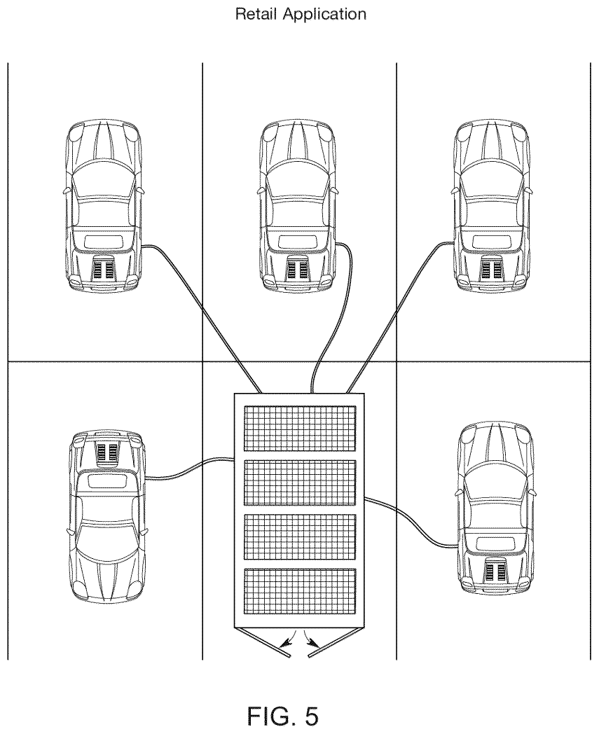

FIG. 5 depicts a retail application of a modular EV charging station according to an embodiment of the present disclosure. As depicted herein, the container housing the modular EV charging station may be placed within a standard parking space in a parking lot. A plurality of EV charging ports may be provided as part of the container, and in this embodiment, five EV charging ports are being used by five vehicles parked in the five parking spaces adjacent to the container housing the EV charging station. However, it should be appreciated that the EV charging ports may include longer lengths of EV charging cables such that more vehicles may access the modular EV charging station in embodiments of the present disclosure. Further, more or fewer EV charging ports may be provided without departing from the present disclosure.

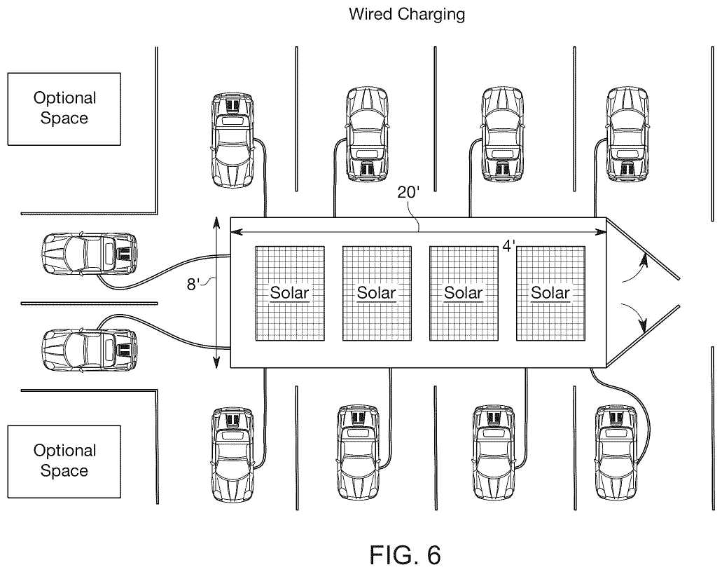

FIG. 6 depicts wired charging using a modular EV charging station according to an embodiment of the present disclosure. As depicted herein, the container housing the modular EV charging station may be placed in an area where multiple vehicles may be parking on three out of four sides of the container. A plurality of EV charging ports may be provided as part of the container, and in this embodiment, ten EV charging ports are being used by ten vehicles parked in ten parking spaces adjacent to the container housing the EV charging station. However, it should be appreciated that the EV charging ports may include longer lengths of EV charging cables such that more vehicles may access the modular EV charging station in embodiments of the present disclosure. For example, FIG. 6 depicts two optional spaces where vehicles may be parked for EV charging, and more or fewer spaces may be provided around the container in embodiments of the present disclosure. Further, more or fewer EV charging ports may be provided without departing from the present disclosure.

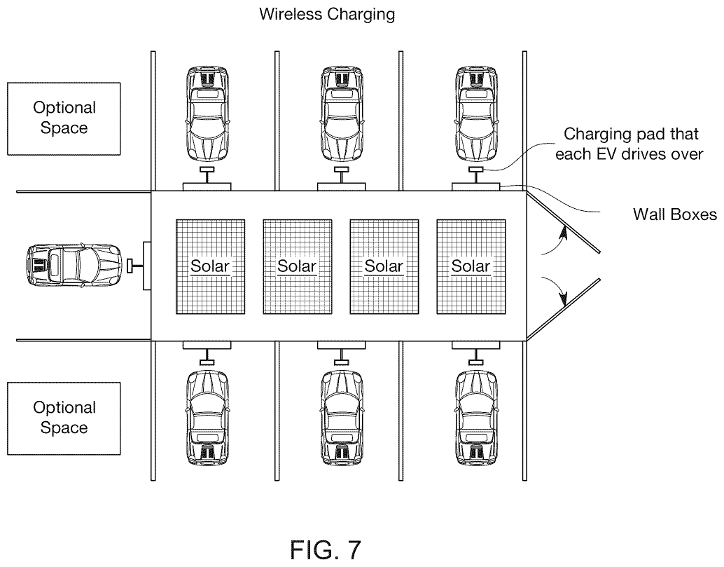

FIG. 7 depicts wireless charging using a modular EV charging station according to an embodiment of the present disclosure. As depicted herein, the container housing the modular EV charging station may be placed in an area where multiple vehicles may be parking on three out of four sides of the container. A plurality of EV charging pads may be provided as part of the container, and in this embodiment, seven EV charging pads are being used by seven vehicles parked or otherwise positioned in seven parking spaces adjacent to the container housing the EV charging station. However, more or fewer EV charging pads may be provided without departing from the present disclosure. For example, FIG. 7 depicts two optional spaces where vehicles may be parked for EV charging, and more or fewer spaces may be provided around the container in embodiments of the present disclosure. The EV charging pad may be provided so that a vehicle may drive over the charging pad to be charged. A wall box may be provided/associated with each charging pad so that the charging pad can communicate with the internal charging equipment associated with the container. However, there may be embodiments of the present disclosure where a single wall box may be associated with more than one charging pad.

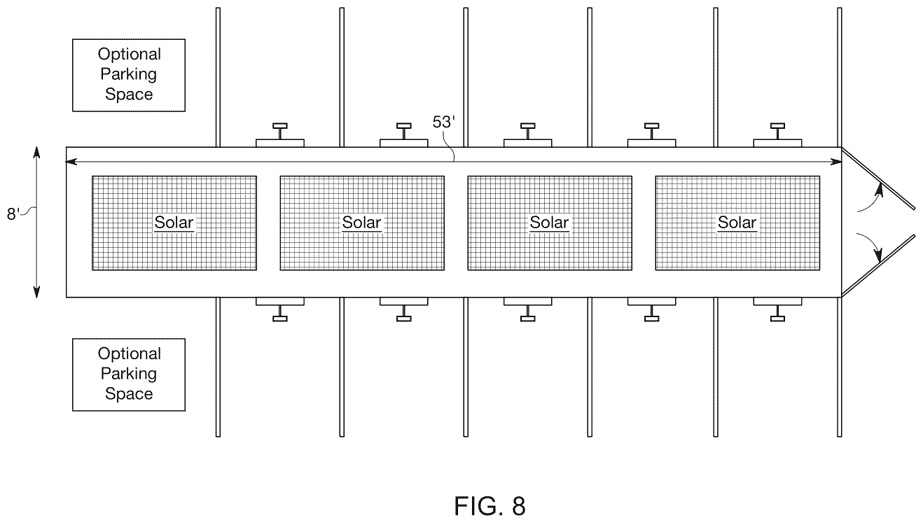

FIG. 8 depicts another configuration of a modular EV charging station according to an embodiment of the present disclosure. As depicted herein, a larger container (53-feet-long) may be used to house the EV charging station. In this configuration, four EV charging pads and wall boxes may be provided on each of the longer sides of the container and one EV charging pad and wall box may be provided on the short side of the container opposite the side where the swinging doors may be provided on the container. However, more or fewer EV charging pads may be provided without departing from the present disclosure. For example, FIG. 8 depicts two optional spaces where vehicles may be parked for EV charging, and more or fewer spaces may be provided around the container in embodiments of the present disclosure.

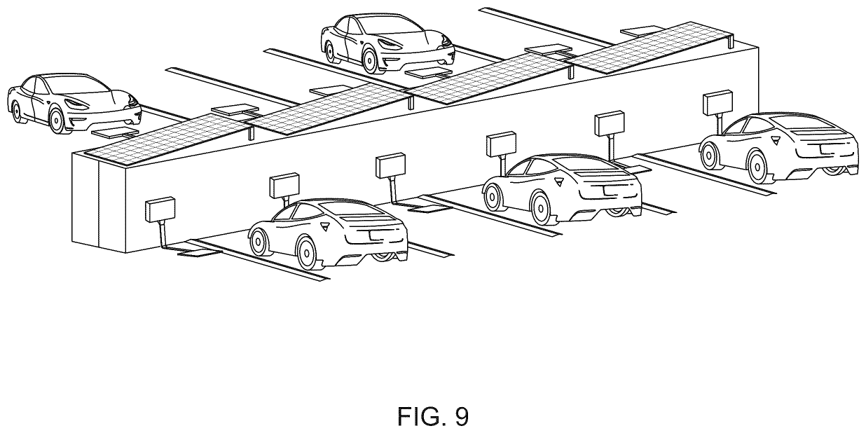

FIG. 9 depicts another view of a wireless modular EV charging station according to an embodiment of the present disclosure. As depicted herein, six EV charging pads and wall boxes may be provided on each of the longer sides of the container. However, more or fewer EV charging pads may be provided without departing from the present disclosure. Further, only some charging pads may be in use at a given time. For example, FIG. 9 depicts how five vehicles are in spaces using charging pads, leaving seven spaces with charging pads available for other vehicles to use for charging.

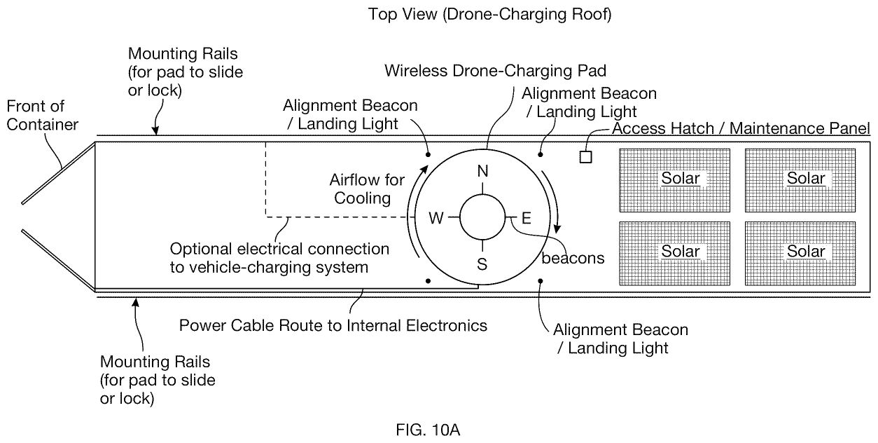

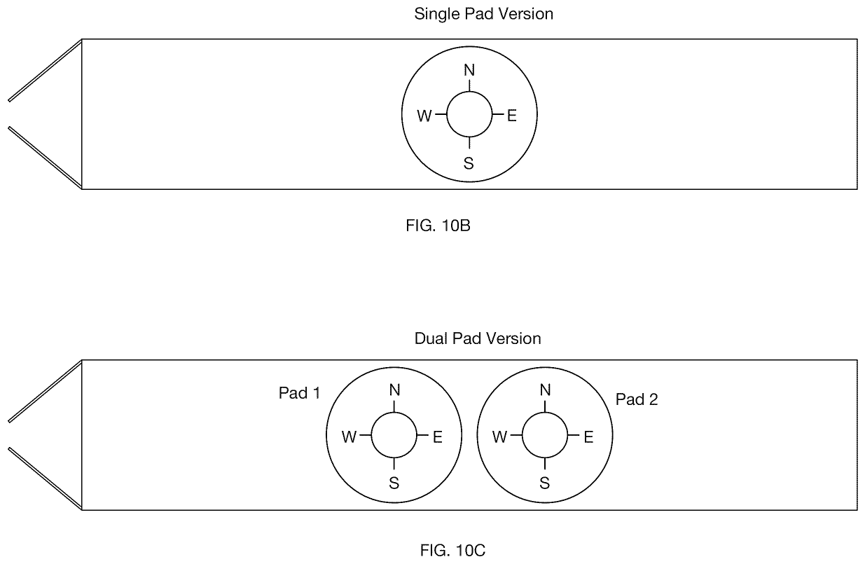

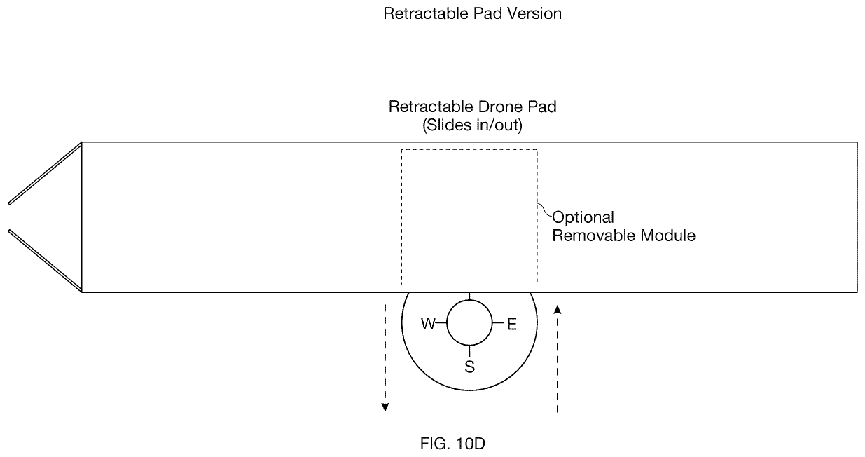

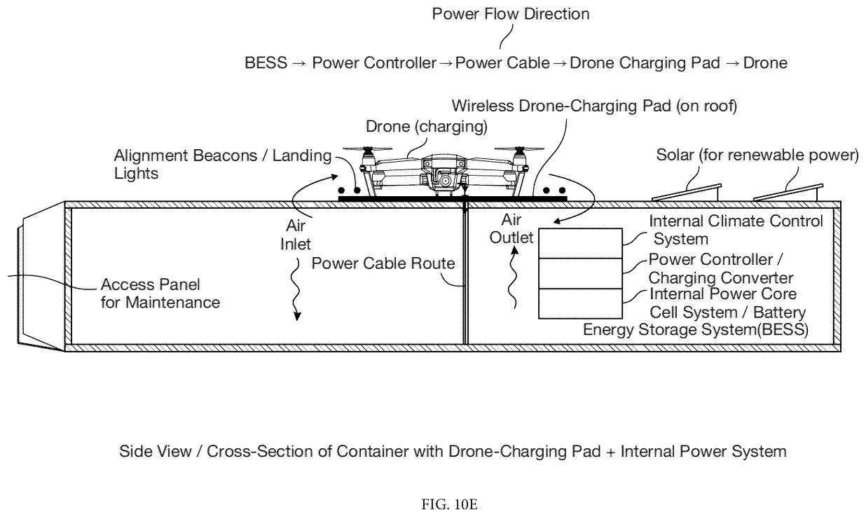

FIGS. 10A-10E depict a wireless drone-charging module positioned on the top surface of the container according to an embodiment of the present disclosure. More specifically, FIG. 10A depicts a top view of a drone-charging roof. The module may include one or more charging pads, one or more landing alignment beacons/landing lights, and safety interlocks for autonomous aerial vehicle positioning. Each pad may be configured for inductive or resonant wireless energy transfer and may be thermally managed by the container's existing climate-control system. FIG. 10B depicts a single pad version, and FIG. 10C depicts a dual pad version. FIG. 10D depicts a retractable pad version where the retractable drone pad may slide in/out, and there may be an optional removable module. There may be mounting rails for the charging pad to slide or lock. Communication between the drone and the charging hub may occur through short-range radio or optical links that authenticate the drone prior to power transfer. The drone-charging module may operate independently or in coordination with vehicle-charging operations, prioritizing power flow through the hub's energy-management controller. FIG. 10E depicts a side view/cross-section of a container with a drone-charging pad and an internal power system. The power flow direction may be from BESS to power controller to power cable to drone charging pad to drone in an embodiment of the present disclosure. There may be an optional electrical connection to a vehicle-charging system. There also may be airflow for cooling (such as air inlet and air outlet in FIG. 10E), an access hatch/maintenance panel, and one or more solar panels. In certain embodiments, retractable or modular drone-charging units may be mounted on roof rails allowing removal or replacement without altering the primary EV-charging functions. Internal components may include an internal climate control system, a power controller, a charging converter, an internal power core, and/or a cell system/BESS in an embodiment of the present disclosure (see, e.g., FIG. 10E).

It should be appreciated that the container housing the modular EV charging station may be in fixed position or may be movable/temporarily positioned in embodiments of the present disclosure. If the container is to be temporarily positioned, it may be delivered to a desired location which may include, but is not limited to, a fleet depot, a highway rest area, a commercial or apartment building parking garage, or another more remote area that may have insufficient or limited EV grid infrastructure or where rapid EV adoption may be projected. The container may be positioned at the temporary site, where it may function immediately utilizing stored solar energy and/or by integrating into a local microgrid. This built-in energy management system also may ensure optimal charging efficiency while protecting the equipment from power surges or overloads. In some embodiments of the present disclosure, the modular EV charging station may connect to an electrical grid associated with the location for hybrid use which may offer continuous power supply regardless of weather conditions. The mobile nature of the modular EV charging station according to embodiments of the present disclosure may allow for relocation as needed.

The EV charging station according to embodiments of the present disclosure has been described herein as modular. Accordingly, additional containers can be added in parallel to increase capacity as demand grows. Accordingly, the modular nature of the EV charging station according to embodiments of the present disclosure may provide a flexible and sustainable charging solution on either a permanent or a temporary basis. For example, a modular EV charging station according to embodiments of the present disclosure may be used at sporting or entertainment events including, but not limited to, the Olympics, Coachella, the Super Bowl, as well as concerts, festivals, weddings, and the like. As the modular EV charging station according to embodiments of the present disclosure prioritizes quick installation, ease of transport, as well as energy independence, the modular EV charging station may be ideal for temporary events, roadside stops, or areas with limited grid access. It also may significantly reduce the carbon footprint compared to traditional, grid-dependent EV charging stations.

There may be alternative embodiments and applications of the modular EV charging station that may expand its versatility. There may be an embodiment of the present disclosure which may be grid-connected in areas with stable grid access. Accordingly, the modular EV charging station may directly connect to a local power grid to supplement energy demands during peak hours. The integrated solar panels and microgrid capabilities may still provide redundancy and lower overall energy costs.

In another embodiment of the present disclosure, the container may incorporate small-scale wind turbines, especially in regions with high wind availability. This may allow for more diverse renewable energy inputs, making the modular EV charging station according to embodiments of the present disclosure adaptable to varying environmental conditions.

In a further embodiment of the present disclosure, the modular EV charging station may be configured as a mobile unit which may be mounted on a truck or trailer. This may allow for mobile, on-demand charging services for vehicles in various circumstances including, but not limited to, emergency situations, remote locations, and/or at temporary events.

If solar or wind power is not available in a location, a battery storage-only solution may be provided in embodiments of the present disclosure. The container may operate purely as a portable battery storage unit which may be charged through external sources to power vehicles when grid power is not available. Other forms of fuel, including, but not limited to, portable hydrogen cartridges, may be included as part of the EV charging station as an alternative fueling option in embodiments of the present disclosure.

A modular EV charging station according to embodiments of the present disclosure may be adapted for specialized applications such as for military, disaster relief, or remote industrial operations where a reliable, off-grid energy source may be critical. In these applications, the container being used as the EV charging station may be equipped with additional features including, but not limited to, ruggedized components, water purification systems, or satellite communication equipment to support broader logistical needs.

It also should be appreciated that exterior walls of the container comprising the modular EV charging station may be used for digital video marketing applications in some embodiments of the present disclosure. These various alternative embodiments may allow the modular EV charging station to be flexible across diverse energy environments, industries, and locations, expanding beyond standard EV charging.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

1. A modular electric vehicle (EV) charging station comprising:
a container formed of a durable material;
one or more integrated solar panels on the container;
a battery energy storage system (BESS) paired with the one or more integrated solar panels; and
one or more EV charging pads compatible with a plurality of electric vehicles.

2. The modular EV charging station of claim 1, wherein the one or more integrated solar panels are on a roof of the container.

3. The modular EV charging station of claim 1, wherein the one or more integrated solar panels are on one or more side surfaces of the container.

4. The modular EV charging station of claim 1, wherein the modular EV charging station is wired or wireless.

5. The modular EV charging station of claim 1, wherein the modular EV charging station fits within a standard parking space without exceeding dimensions of the standard parking space.

6. The modular EV charging station of claim 1 further comprising:
a plurality of EV charging ports.

7. The modular EV charging station of claim 6, each of the plurality of EV charging ports comprising:
a charge confirm display, internal EV charging equipment, and an EV charging cable.

8. The modular EV charging station of claim 1 further comprising:
one or more doors on an end of the container that allow access to internal components of the modular EV charging station.

9. The modular EV charging station of claim 7, wherein the internal components comprise an internal power core cell system and an internal climate control system.

10. The modular EV charging station of claim 1 further comprising:
a drone charging subsystem disposed on a roof of the container.

11. The modular EV charging station of claim 10, wherein the drone charging subsystem employs one or more of the following power transfer mechanisms for charging:
inductive power transfer, resonant power transfer, and directed-beam wireless power transfer.

12. The modular EV charging station of claim 11, wherein power is drawn from the BESS, the one or more solar panels, and/or a microgrid surface.

13. The modular EV charging station of claim 10, wherein the drone charging subsystem is removable, retractable, or configurable to accommodate a plurality of drone sizes.

14. The modular EV charging station of claim 1, wherein the modular EV charging station is in a fixed position.

15. The modular EV charging station of claim 1, wherein the modular EV charging station is mobile for temporary positioning.

16. The modular EV charging station of claim 1, wherein the modular EV charging station is grid-connected through to a local power grid.

17. The modular EV charging station of claim 1, wherein the modular EV charging station incorporates small-scale wind turbines.

18. The modular EV charging station of claim 1, wherein the modular EV charging station is configured as a mobile unit mountable on a truck or a trailer.

19. The modular EV charging station of claim 1, wherein the modular EV charging station is operable as a portable battery storage unit charged through external sources.
